(19) United States
(12) Patent Application Publication
(10) Pub. No.: US 2014/0067536 A1
(43) Pub. Date: Mar. 6, 2014

(54) Value to the people

(71) Applicant: Jonathan Pierson, Los Angeles, CA (US)

(72) Inventor: Jonathan Pierson, Los Angeles, CA (US)

(21) Appl. No.: 13/603,407

(22) Filed: Sep. 4, 2012

(51) Int. Cl. G06Q 30/02

(52) U.S. Cl. 705/14.55

(57) ABSTRACT

The core of the invention is in the user's ability to view websites and programs that display advertisements from advertisers that the user has chosen to be exposed to. The added ability to choose who receives the revenue earned is only an additional option and is an improvement upon the core of the invention if it was without this option. The user is any person that is utilizing the invention on a website or within a computer program. This is a method of controlling advertisements so that the users choose which advertisements display and they can also choose to control a percentage of the revenue from the advertisements that display on websites and within computer programs. This includes the ability for a user of a website/program to click and choose advertisements that will appear on any site/program they are using.

### SUMMARY OF INVENTION

The core of the invention is in the user's ability to view websites and programs that display advertisements from advertisers that they have chosen to be exposed to. The added ability to choose who receives the revenue earned is only an additional option and is an improvement upon the core of the invention if it was without this option. The user is any person that is utilizing the invention on a website or within a computer program. This invention is a method of controlling advertisements so that the user's choose which advertisements display and they can also choose to control a percentage of the revenue from the advertisements that display on websites and within computer programs. This includes the ability for a user of a website/program to click and choose advertisements that will appear on any site/program they are using. They can choose the advertisements prior to visiting the site or during their time using the website or computer program. The users can choose using an attached option on the advertisement or within the website or program. This improves current methods of advertising by allowing the user of the site to choose which advertisements display and who receives a percentage of the revenue. This method tracks the actions of the user and collects data. This data is used to determine which advertisements to display, where to send the revenue and how much revenue has been earned. The first step is to receive the input from the user in regards to which advertisements they want to appear while they visit a website or use a computer program; in the case of a social network the owner of the profile/content can choose which advertisements display. The second step is determining who they want their percentage of the revenue to go to. Input is gathered using any capable utility; software is a good example. The second step is optional and isn't a necessary part of the invention process, the core of the invention is in the user's ability to view websites that display advertisements from advertisers that they have chosen to be exposed to. The third step is tracking the user's actions using software and displaying the advertisements that are chosen by the user. The user's actions are tracked in order to figure out how much revenue is earned from their activities. Tracking is done using software/website, it is designed to analyze and record the data from the user's actions on a website or within a computer program.

This invention is best represented by a social network where the user's control what advertisements appear on their profile and around their content; an essential part is also the user's ability to control who receives a percentage of the revenue earned from advertising whether they control which advertiser's display or not. This also includes control of who receives the revenue from advertising on websites and programs that the user uses, so if a user goes to cnn.com they can send the red cross a percentage of the revenue earned from the advertising they interact with on the website. They choose the recipient using any capable utility including a dedicated website or program.

In the case of a social network, the owner of the profile/content can also choose which advertisements display on their profile/content and who will receive a percentage of the revenue earned from the advertisements. In the case of a social network or search engine, the owner of the content can choose the advertisements/revenue earned and not the visitor to the site, although this invention also covers the users visiting the content, pages or programs and how they can control the advertisements that display on the website or programs they use. At any time this invention can be turned off by the user or the owner of the website or program, allowing for normal advertisements to be displayed. A key part of this invention is within social networking, it includes a method of advertising consisting of a way for the user of a social network to control the advertisements and who will receive the revenue earned from the advertisements on their profile page and around content that they own, when a person visits their profile they see advertisements selected by the owner of the page and not the owner of the website, this also means that an agreed upon percentage of revenue earned from the advertisements goes to who the owner of the site chooses it to go to.

The users choose the advertisements, within the website or program, or before using them. User's use a website or program in order to pick companies and sponsors to appear on the websites and programs they use. The advertisements are displayed using any capable utility including software. User's use a website or program in order to pick who will receive a percentage of the revenue from their actions online. Any company or person who is interested in signing up for to use this invention simply uses an online interface or offline methods of contacting us in order to set up the ability to have the visitors to their websites/programs choose the advertisements that display and where the revenue goes.

The advertisements are displayed by grouping all of the data collected from the user; the next step is choosing an advertisement to display on their website or program, based off of this data. Software is used to determine what advertisements to display, taking information from the user's recorded input and choosing an ad at random or based on prior information to display advertisements based on the user's past actions online or offline.

In whole this invention consist of the following parts, a social network where the user controls the advertisements that display within websites and on programs, and also who will receive the revenue earned from these advertisements, a social network where the user controls the advertisements that will be displayed within the website or program, a social network where the user controls the revenue earned from advertisements on their profile and around content they own, tracking for this invention, displaying of ads for this invention, a website or program where the user controls which advertisements display and the revenue earned from advertisements that they are exposed to, a website or program where the user controls the advertisements only, and a website or program where the user controls who receives the revenue earned from advertisements on a website or within a program.

### TECHNICAL FIELD

The technical fields associated with this invention are as follows computer programs, advertising, and websites.

### BACKGROUND OF THE INVENTION

This invention is highly necessary, because current advertising online and within programs can become unattractive to the user. By allowing the user to control the advertisement that are displayed, the invention revolutionizes how companies utilize advertising. This invention allows for a personalized internet. In the case of social networks the ability to control the advertisements and who receives the revenue earned, is a major update over current advertising models. This is because the user is able to relate to what appears on the websites and programs using this invention.

2. The method according to claim 1, further comprising the step of: step 1 the user selects a type of advertisement or a category of advertisement that will be displayed.

3. The method according to claim 1, further comprising the step of: step 1 The user selects advertisements directly within the program or website they are using.

4. The method according to claim 1, further comprising the step of: Step 1 The user chooses who will receive the revenue earned from the advertisements, directly within the program or on the website.

5. A method of advertising on the internet or within a program, comprising the steps of: Step 1 input is received from the user about which advertisements they want to display and who will receive a percentage of the revenue earned from advertisements; step 2, the users data is recorded using software or the internet; Step 3 The website or program can access the data, and then advertisements are displayed at random or based on the users past activity online; step 4, the data is tracked and recorded in order to find out which advertisers the user has interacted with; step 5, the data received is analyzed using software and percentage of the revenue earned is sent to who the user chose it to be sent to.

6. A method of advertising on the internet or within a program, the method comprising the following steps: step 1, The user of a website or program chooses who receives a percentage of the revenue earned from advertisements that the user interacts with within the internet or a computer program; step 2, any capable utility including software is used to record the data collected from the user; step 3, the users actions are recorded using any capable utility, the recorded data is stored in a database; step 4, the website or program accesses this database to determine how much revenue to pay to the users choice of recipient; step 5, based on the data recorded the users selection is given a percentage of the revenue earned from the advertisements.

7. A method of advertising on the internet or within a program, comprising the steps of: step 1 The user of a social network chooses which advertisements display within their profile and around the content they own; step 2, the user selects advertisements using any capable utility including a dedicated website; step 3, the input is then collected and stored in a database; step 4, the website or program accesses the users input and the selected advertisements display within their profile and on/around their content through any capable utility including software that displays them using random selection.

8. A method of advertising on the internet or within a program, the method comprising the steps of: step 1, the user of a social network chooses who receives a percentage of revenue earned from the advertisements on the user's profile and around content they own; step 2, the user selects who will receive the revenue earned from the advertisements, using any capable utility including a dedicated website; step 3, the users input is then collected and stored in a database; step 3, the website or program accesses the users information and they then pay out any revenue earned to whoever the user selected.

9. A method of advertising on the interne or within a program, comprising the steps of: step 1, the user of a social network chooses the advertisements that will be displayed and who will receive the revenue earned from the advertisements on their profile page and around content that they own; step 2, the website accesses the data from the user, and when a person visits the profile/content, advertisements selected by the owner of the page/content are displayed; step 3, a agreed upon percentage of revenue earned from the advertisements goes to who the owner of the profile/content selected it to go to.

10. A method of tracking user data within a website or program comprising the step of: step 1 any capable utility is used to track and record data, including software which records the users choice in advertisements and who will receive the revenue earned from advertisements.

11. A method of displaying advertisements comprising the steps of: step 1 data from user input is gathered, the users choice in advertisers are selected and recorded; step 2,the software within a website or within a program then displays an advertisement based on past user activity or using random selection.

12. A method of advertising within a social network comprising the steps of: step 1 the user accesses their profile or visits the page where their content is located; step 2, the user chooses which advertisements will display by inputting html code into the advertisement areas or selecting which advertisements will display directly within a dedicated area; step 3, the user's selections and input is recorded and stored into a database; step 4, the social network accesses the database and advertisements are displayed, on the users profile or on/around the content they own, using any capable utility.

13. The method according to claim 12, further comprising the step of: step 1 the user selects advertisements or inputs html code for advertisements from one page within the social network; step 2, the users selections and input are recorded and stored into a database; step 3, the social network accesses this database and displays advertisements, according to the users input, when visitors arrive to the users profile or when content is visited;
